(19) United States
(12) Patent Application Publication
(10) Pub. No.: US 2011/0033655 A1
(43) Pub. Date: Feb. 10, 2011

(54) Energy saving honeycomb having enhanced strength

(76) Inventor: Rainer K. Duchene, Natick, MA (US)

Correspondence Address: Stephen B. Salai, Esq.;Harter Secrest & Emery LLP, 1600 Bausch & Lomb Place, Rochester, NY, 14604-2711, US

(21) Appl. No.: 12/462,669

(22) Filed: Aug. 7, 2009

(51) Int. Cl. B32B 3/12; B29C 45/14; B29C 44/12

(52) U.S. Cl. 428/118; 428/116; 264/241; 264/45.3

(57) ABSTRACT

An injection molding method of producing a honeycomb body involves introducing an injection moldable polymer into a mold having a two-dimensional array of parallel pins separated from each other in a manner forming inter-cell reinforcement volumes between honeycomb cells being molded for strengthening the honeycomb. The pins can be cylindrical or have hexagonal shapes, trapezoidal shapes, and diamond shapes. Reinforcement fibers can be introduced into the polymer for even further strengthening the honeycomb body. Foaming agents can be added to the molten polymer with or without the fibers to decrease the density of the honeycomb and reduce heat transfer through the honeycomb for saving energy. Roughening, or producing textured surfaces of the honeycomb product can reduce glare due to sunshine that is detrimental should the honeycomb be used in the construction of buildings and the like. Foaming agents introduced into the polymer during molding can also produce such textured surfaces.

### BACKGROUND OF THE INVENTION

Honeycomb structures have been known and used for a long time for example to create a structurally strong sandwich panel in combination with a variety of skin materials. Metal and fiber reinforced paper honeycombs are very common. Thermoplastic honeycombs were introduced to the market beginning of the seventies of last century but only managed to enter into a small range of possible applications. The main reason is the mechanical property of the core. Thermoplastic cores need to have a very thin wall thickness to reach commonly used material densities of 4 lbs/ft³ to 6 lbs/ft³. In order to achieve such low densities the typical wall thickness of such a honeycomb is in the range of 60 μm to 200 μm. However most costs efficient fibers (Glass, natural fibers or even carbon fibers) have already a size larger than 200 μm. For that reason they cannot be positioned in the cell walls to strengthen them.

Weight savings are becoming more and more important in most current and many possible future applications for such a honeycomb. For that reason there is a strong need to improve the mechanical properties of the thermoplastic honeycomb.

A commonly used well performing honeycomb is made out of Nomex/Aramid fiber paper and then impregnated with a resin like phenolic. This technology allows achieving low densities along with having good mechanical properties. However such structures are expensive to make, impossible to recycle, and tend to be hydrophobic which reduces the product life cycle.

### BRIEF SUMMARY OF PREFERRED EMBODIMENTS OF THE INVENTION

An injection molding method of producing a honeycomb body involves introducing an injection moldable polymer into a mold having a two-dimensional array of parallel pins separated from each other in a particular manner, forming inter-cell reinforcement volumes between honeycomb cells being molded for strengthening the honeycomb. The pins can be cylindrical or have hexagonal shapes, trapezoidal shapes, and diamond shapes. Reinforcement fibers can be introduced into the inter-cell reinforcement volumes for even further strengthening the honeycomb body. Also, foaming agents can be added to the molten polymer, with or without the fibers, to decrease the density of the honeycomb and also reduce heat transfer rates through the honeycomb for saving energy.

In accordance with another aspect of the invention, the injection molding process will allow producing different surface finishes. The current known extrusion technologies make tubular honeycomb polymer surfaces shiny. This creates a detrimental glare effect in the architectural transparent facades when the sun is shining. The pins of the mold however can be surface treated, allowing for a textured surface to avoid this glare effect. A similar beneficial result can be obtained by introducing foaming agents into the polymer during molding. This aspect of the invention may open up the entire architectural transparent façade business.

### BRIEF DESCRIPTION OF THE DRAWINGS

Other aspects of the invention will become more apparent upon study of the following description taken in conjunction with the drawings in which:

FIGS. 1-3 disclose portions of the two-dimensional array of cylindrical pins 2 of the injection mold, and FIG. 1 additionally illustrates at the same time a portion of the resulting honeycomb body having the tubular cell walls 4 and inter-cell reinforcement volumes 6 thereof.

FIGS. 4, 5, and 6 disclose hexagonal, trapezoidal and diamond shaped molding pins respectively for forming honeycombs having alternate cell shapes.

### DETAILED DESCRIPTION OF PREFERRED EMBODIMENTS OF THE INVENTION

It is deemed desirable to provide additional honeycomb surface area for better resisting compression forces and which such additional surface area enables the ability to add strengthening fiber reinforcements to the honeycomb.

Both of these features are not practical with current production processes and technologies, and hence in accordance with a first embodiment of the invention an inter-cell triangular reinforcement volume is produced between the tubular cell openings to allow for more surface area and to be able to contain added fiber reinforcements into such triangular volumes. This will increase tremendously the mechanical properties of the core.

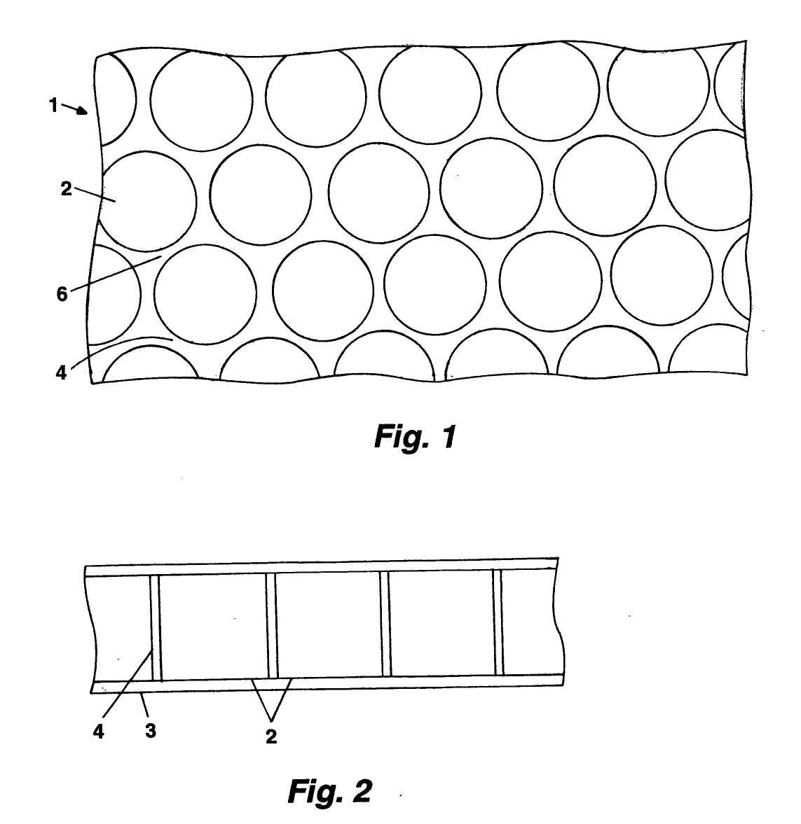

An aspect of the invention is to make a thermoplastic tubular honeycomb structure with wall thicknesses smaller than 1500 μm (1.5 mm), and preferably less than 1 mm, which corresponds to the smallest distance between two pins of an injection mold having a two dimensional array of parallel pins forming the product shown in FIGS. 1 and 2 that are further described below. Since fibers have much greater diameters than these thin walls, they cannot be contained within the walls. The inter-cell triangular volume 6 in FIG. 1, will be filled with solid polymer. If desired, such a triangular volume formed between the honeycomb cells to be described will provide enough volume to introduce commonly used fiber reinforcements like glass fibers, natural fibers or carbon fibers for strengthening the product. Such a structure could be made out of any injection moldable polymer.

Solid wall honeycombs have however a clear disadvantage compared to foam regarding their insulation values due to the solid cell walls running parallel to each other. Insulation values are of great importance in saving energy used to heat and cool buildings and other structures. These solid walls, even when very thin, are very good heat conductors. In contrast, foams, although having very good thermal insulating properties due to small air bubbles enclosed inside it, have poor mechanical properties.

Thus in accordance with another aspect of the invention, air bubbles are formed within the solid walls and triangular volumes during injection molding, beneficially reducing the density of the honeycomb while insulation value will increase, but still keeping much better mechanical properties than the foam.

This invention allows as well, producing a very low density structural honeycomb as for example demanded in the aerospace industry. The current thermoplastic honeycomb technologies allow making a honeycomb not lower than 3 lbs/ft³. In the aircraft interior however a 2 lbs/ft² honeycomb is widely used. The current invention allows now for the first time to foam the chosen polymer to a level that such a low density honeycomb can be reached. The possibility to add fiber reinforcements to the novel injection molding process to be described will make it possible to achieve greater strength of the honeycomb as well By introducing air bubbles into the solid honeycomb walls, the wall thickness will increase while keeping the density low since air is very light. This increased wall thickness will allow for more surface area of the core to bond skins to. This effect is quite considerable since more surface area will provide a better bond of a skin to the core.

Foamed walls of this invention could be applied to any given geometry be it tubular, hexagon, Polygons, wave like structures etc. The key benefits regarding honeycomb production would be to:
Increase insulation value;
Allow for honeycomb densities below 8 lbs/ft³;
Introduce fiber reinforcements to increase mechanical properties;
Create various surface finishes on the inside and outside of the honeycomb walls;
Increase compressive strength (which increase can be linear to the given surface area).

In accordance with another aspect of the invention, since the novel honeycomb can be made out of a single polymer, it can be easily recycled and reused; if fibers are added these will increase the mechanical properties of the recycled material as well.

Many current tubular structures like those mentioned in my U.S. Pat. No. 5,683,782 incorporated herein need to use an outer and inner layer of a polymer where the outer layer need to have a lower melting point by at least 30° C. This is not the case with the present invention. Hence the temperature stability will be 30° C. better which is a very important point given the fact that polypropylene has often a softening point of less than 100° C.

In a second process the injection molded honeycomb structures can be welded to a larger size sheets like commonly used 8′×4′ and then pressed with two skins into a sandwich panel. Such a welding process would be automated to allow high accuracy.

A major benefit of a honeycomb made according to the present invention, is that can be post formed after molding, by applying heat and will not need expensive cutting, routing or other currently used processes. “Nomex” honeycombs need to incur high additional post treatment costs to take a flat honeycomb sheet and prepare it, for example, for a 3-dimensionally shaped side wall cover for an aircraft interior part. This is even more expensive and complicated to achieve with a metallic honeycomb.

The current worldwide market demand is requiring more and more composites materials which allow for:
Substantial weight savings
High processing speed
Recyclability which means reuse rather than thermal combustion
Low costs.

As shown in FIGS. 1 and 2, in accordance with a first embodiment of the invention, a top view of a portion of a two dimensional cylindrical pin array 1 affixed upon an injection mold base 3 is shown. Rows of individual pins 2 are staggered out of phase with each other as shown in FIG. 1 and the finished tubular circular cell honeycomb will have the appearance as shown in FIG. 1.

The pin gaps 4 between pins 2, designated as the peripheral pin gaps, shown in FIGS. 1-3, are substantially smaller than the largest dimension of the space between pins designated hereinafter as the Reinforcement Space Between Pins or RSBP 5, since when the molton plastic is solidified in the RSBP, this produces the inter-cell triangular reinforcement volumes 6, shown in FIG. 1, which reinforces the honeycomb array and strengthens it.

The inter-cell sizes of the RSBP 5 between cells can vary from 1 mm to 15 mm. However the closest point between two pins or pin gap 4 should not be more than 1.5 mm for the plain polymer version and can be up to 4 mm, due to the fact that in creating the foamed walls to reduce the density of the honeycomb, the volume of the walls will increase. The non-foamed circular cell polymer prototype of FIG. 1, built by the inventor, was made by a mold having a pin gap of 0.4 mm.

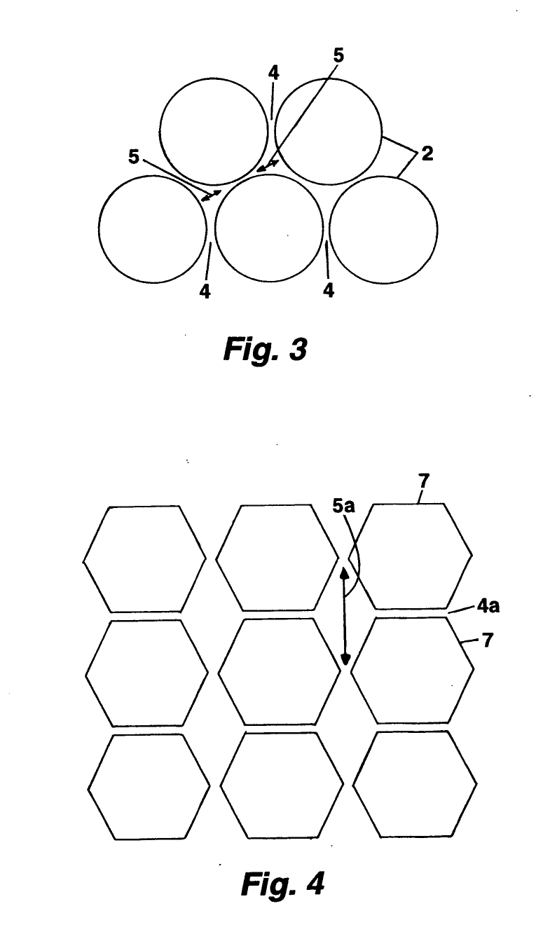

The inventor has determined that good tradeoffs (for example weight v. strength) and beneficial results call for a peripheral pin gap 4 being in the range of between 0.1 mm and 1.5 mm and the RSBP 5 should be in the range of between 1 mm and 15 mm. See FIG. 3.

It is the intention of this invention to create a light weight core material out of a thermoplastic polymer. For most of the intended applications, the core density of the produced core (honeycomb) should be as low as possible. A typical range should be between 2 lbs/ft³ and 10 lbs/ft³. In order to achieve these very low densities it is deemed desirable to restrict the aforesaid RSBP 5 (the reinforcement space between pins) and the peripheral pin gaps 4 (the smallest distance between two pins) to be as low as possible. For example current extruded tubular circular cell honeycombs show a density of 5 lbs/ft³ at a wall thickness of 0.5 mm where the individual tubes touch each other and hence the need to keep the distance between two pins lower than 1.5 mm. For the tubular circular cell core honeycomb design shown in FIG. 1, the RSBP is directly correlated to the tubular diameter. Thus, the present invention generally covers circular cell sizes from 3.2 mm to 20 mm in open diameter.

While the aforesaid cylindrical pins in the mold having circular cross-sections, are preferred due to simplicity, the mold pins can have other cross sections having similar dimensions to reap the benefits if the invention.

FIG. 4 discloses a portion of a hexagonal shaped pin array forming hexagonal shaped honeycomb cells with RSBP 5a and pin gap 4a as shown. The diamond shaped areas between hexagonal pins 7 would be filled with polymer for forming the reinforcement volumes, like the triangular volumes 6 in the FIG. 1 circular cell embodiment.

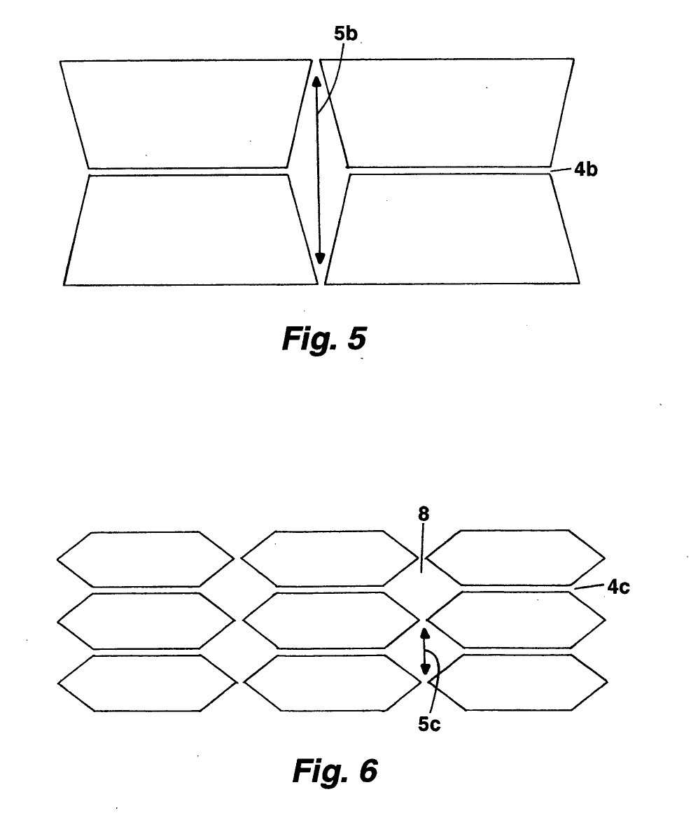

FIG. 5 discloses a portion of a trapezoidal shaped pin array forming trapezoidal shaped honeycomb cells with RSBP 5b and pin gap 4b as shown. The diamond shaped areas would be filled with polymer for reinforcement like the triangular volumes 6 in the FIG. 1 embodiment.

FIG. 6 discloses a portion of a diamond shaped pin array forming diamond shaped honeycomb cells with RSBP 5c and pin gap 4c as shown. The diamond shaped areas 8 would be filled with polymer for reinforcement like the triangular reinforcement volumes 6 in the FIG. 1 embodiment.

In order to release the honeycomb from the mold, the pins should preferably have a slight cone configuration such that the individual pins need to increase its diameter from the highest pin extremity to where it is welded to the plate base 3 of between 1 to 5 degrees.

In accordance with another aspect of the invention as well, the injection molding process will allow producing different surface finishes. The currently widely used extrusion technologies for producing honeycombs make the tubular polymer surfaces shiny. This creates a highly detrimental glare effect in the architectural transparent facades when the sun is shining. The pins of the mold however can be surface treated for creating a textured surface to avoid this glare effect and this step would open up an entire architectural transparent façade business employing honeycombs.

One way of creating a textured surface is by mechanically roughening the surface of the pins. However, if foaming of the polymer is employed to create the core walls and the triangular reinforcement volumes, the wall surfaces will automatically become textured, since it is not possible to create a complete smooth foamed surface. Depending now on the foaming degree and the type of foaming agent used, the surfaces will have very different textures.

This textured surface will provide a highly desirable benefit. Texturing will increase the surface area of the honeycomb. A higher surface area or contact area will increase the contact area for adhesives/materials to adhere to. Since the honeycomb will be used for sandwich panels as well, one main way of creating a sandwich panel is by bonding a skin to the core by using adhesives. Smooth surfaces of core materials do delaminate much faster than rough surfaces due to the higher contact area where the adhesive can adhere to.

Post forming is a widely used process to create two or three dimensional shapes out of flat material. One application for the core material is in personal body protection. Shoulder or knee pads do need a high level of impact absorption in case of an accident. The main material used today is thermoplastic foam. However foams are not as efficient in energy absorption as honeycombs given the same weight/density ratio. Today companies do use already the co-extruded tubular honeycomb. However, due to the two different polymer used in the co-extrusion process, the outer polymer layer of the honeycomb has a melting point about 30° C. lower than the inner polymer layer, does not form homogenously and hence is not widely used. With the present invention, this does not happen anymore. Since only one polymer is preferably employed, the melting point is not distorted and shapes very homogenously.

Regarding the post forming process, the flat core material of the honeycomb, is taken and heated between a heat source to a temperature slightly before the melting point of the given polymer. It is then immediately moved to the shaping press and cooled at the same time. This allows for a very fast production process. This process can be made just for the honeycomb but it can incorporate as well additional textile layers to assemble the final absorber product which will then be placed inside the pouch of the motorbike jacket or motorbike trouser.

While the invention has been described in connection with preferred embodiments, the description is not intended to limit the scope of the invention to the particular forms set forth, but on the contrary, it is intended to cover such alternatives, modifications, and equivalents as may be included within the spirit and scope of the invention as indicated by the language of the appended claims.

What is claimed is:

1. A method of producing an injection molded honeycomb body comprising the steps of:
(a) providing an injection mold having a two-dimensional array of parallel pins separated from each other by
(i) reinforcement spaces between pins of between 1.0 and 15.0 millimeters for forming inter-cell reinforcement volumes upon solidification of said moldable polymer; and
(b) (a) introducing an injection moldable polymer into said injection mold.

2. The method of claim 1 wherein said pins are substantially cylindrical for forming circular honeycomb cells.

3. The method of claim 1 wherein said pins have configurations selected from the group consisting of hexagonal shapes, trapezoidal shapes, and diamond shapes.

4. The method of claim 1 wherein reinforcement fibers are introduced into said polymer for strengthening said honeycomb body.

5. The method of claim 2 wherein reinforcement fibers are introduced into said polymer for strengthening said honeycomb body.

6. The method of claim 3 wherein reinforcement fibers are introduced into said polymer for strengthening said honeycomb body.

7. The method of claim 1 including the step of roughening surface portions of said pins for reducing a glare effect in said honeycomb bodies upon being illuminated.

8. The method of claim 2 wherein rows of said pins are staggered out of phase relative to each other.

9. A method of producing an injection molded honeycomb body comprising the steps of:
(a) providing an injection mold having a two-dimensional array of parallel pins separated from each other by
(i) reinforcement spaces between pins of between 1.0 and 15.0 millimeters for forming inter-cell reinforcement volumes upon solidification of said moldable polymer between honeycomb cells being molded; and
(ii) peripheral pin gaps of between 0.1 and 4.0 millimeters for forming honeycomb walls connecting said inter-cell reinforcement volumes upon solidification of said moldable polymer; and
(b) introducing an injection moldable polymer along with a foaming agent into said injection mold.

10. The method of claim 9 wherein said pins are substantially cylindrical for forming circular honeycomb cells.

11. The method of claim 9 wherein said pins have configurations selected from the group consisting of hexagonal shapes, trapezoidal shapes, and diamond shapes.

12. The method of claim 9 wherein reinforcement fibers are introduced into said polymer for strengthening said honeycomb body.

13. The method of claim 10 wherein reinforcement fibers are introduced into said polymer for strengthening said honeycomb body.

14. The method of claim 11 wherein reinforcement fibers are introduced into said polymer for strengthening said honeycomb body.

15. (canceled)

16. (canceled)

17. (canceled)

18. (canceled)

19. (canceled)

20. (canceled)

21. (canceled)

22. (canceled)

23. A method of producing a honeycomb body comprising the steps of:
(a) introducing an injection moldable polymer into an injection mold having a two-dimensional array of parallel pins configured to shape cells of said honeycomb body; and
(b) creating textured surfaces upon said honeycomb injection molded.

24. The injection molding method of claim 23 wherein step (b) is carried out by roughening surface portions of said parallel pins.

25. The injection molding method of claim 23 wherein step (b) is carried out by introducing a foaming agent into said injection mold along with said moldable polymer.
